(19) United States
(12) Patent Application Publication
(10) Pub. No.: US 2026/0184063 A1
(43) Pub. Date: Jul. 2, 2026

(54) FOIL PRINTING MACHINE AND SYSTEM

(71) Applicant: Norwalt Design, Inc., Randolph, NJ (US)

(72) Inventor: Michael Seitel, Randolph, NJ (US)

(73) Assignee: Norwalt Design, Inc., Randolph, NJ (US)

(21) Appl. No.: 19/379,900

(22) Filed: Nov. 5, 2025

Related U.S. Application Data
(60) Provisional application No. 63/741,180, filed on Jan. 2, 2025.

(51) Int. Cl. B41F 16/00; B41F 19/00

(52) U.S. Cl. CPC B41F 16/0086; B41F 19/004

(57) ABSTRACT

A system for applying foil indicia onto a surface of a container includes an elongate foil film having a metalized layer; a foil drum for moving the elongate foil; a continuous container transfer station having a container holder for releasably securing a container. The continuous container transfer station being configured for moving the container from an infeed container station to a foil-container contact location. The container holder includes a motor system for moving the container into contact with the foil and for moving the container away from contract with the foil and includes at least one additional motor for rotating the container. Upon contact of the container to the foil, the foil indicia is transferred from the foil to the container. The tangential velocity of the container is controlled to be substantially equal to a surface velocity of the foil at a point of the foil-container contact location.

### CROSS-REFERENCE TO RELATED APPLICATIONS

This application claims the benefit of U.S. Provisional Application No. 63/741,180, filed Jan. 2, 2025, the contents of which is incorporated by reference herein.

### FIELD OF THE INVENTION

The present invention is directed to a machine or system for printing foil onto a surface of a container. In particular, the present invention is directed to a machine or system using a foil transfer for depositing foil onto the surface of the container.

### BACKGROUND OF THE INVENTION

Foil transfer printing onto a container is a method used to so customize containers. Foil transfer machines are typically slow as movement of containers is halted in the prior art systems while foil is being applied to any particular container. Further, misalignment of the transferred foil onto a container may be problematic.

As such, there is a need in the art for improved foil transfer printing onto a container.

### SUMMARY OF THE INVENTION

The present invention is directed to a system for transferring foil including foil indicia, such as artwork, from a foil film onto a container. The system provides improved and controlled transfer of foil indicia from the foil onto a surface of the container.

The present invention is directed to a system for applying foil indicia onto a surface of a container may include:
an elongate foil or foil film having a metalized layer and a base layer;
a rotating device for moving the elongate foil;
a continuous container transfer station having a plurality of container holders, each one of the plurality of container holders for releasably securing a container, the continuous container transfer station configured for moving the container from an infeed container station to a foil-container contact location; and
an adhesive jetting and curing station for applying and partially curing adhesive;
wherein each one of the container holders comprise a motor system for moving the container into contact with the foil and for moving the container away from contact with the foil and comprises at least one additional motor for rotating the container;
where, upon contact of the container to the foil, a portion of the metalized layer is adhesively transferred from the foil to the container; and
where the at least one additional motor rotates the container whereby a tangential velocity of the container is substantially equal to a surface velocity of the foil at a point of the foil-container contact location.

The rotating device may be is a foil drum for guiding the foil. The system may

further include a belt, a motor, a pinion gear system, or other means for rotating the foil drum controls the tangential velocity of the foil at the foil-container contact location.

The rotating device may be a rotating spindle or pulley for moving and controlling the tangential velocity of the foil at the foil-container contact location.

The system may further include a backup guide for guiding the foil at the foil-container contact location.

The motor system controls the tangential velocity of the container at the foil-container contact location.

The container holder may include an upper container holder and a lower container holder. The motor system may include first and second motors mechanically associated with the upper container holder and/or mechanically associated with the lower container holder. At least one of the first and second motors may be configured to controllably move the upper and lower container holders towards and away from the foil. At least one of the first and second motors may be configured to controllably rotate the container.

The container may have a substantially circular cross-section where the foil is being applied thereto.

The motor system may be further configured for positioning the container proximal to the adhesive jetting and curing station. The motor system may be further configured for positioning surfaces of the container juxtaposingly proximal to the adhesive jetting and curing station. The motor system may be further configured for positioning surfaces of the container tangentially proximal to the adhesive jetting and curing station.

The container may have a non-circular cross-section where the foil is being applied thereto. The container may have an oblong cross-section where the foil is being applied thereto.

The system may further include an ink printing and curing station for printing ink onto the container.

A method for applying foil indicia onto a surface of a container, may include:
providing an elongate foil having a metalized layer and a base layer;
providing a rotating device for moving the elongate foil;
providing a container releasably secured within a container holder;
providing a continuous container transfer station having a plurality of container holders;
providing a motor system mechanically associated with each of the container holders for moving the container towards the foil and for rotating the container;
providing adhesive jetting and curing station;
applying and partially curing adhesive onto a surface of the container;
contacting the rotating container and the moving foil at a foil-container contact location; and
adhesively transferring a portion of the metalized layer from the foil onto the surface of the container while the continuous container transfer station is moving the container from an infeed container station to the web-container contact location.

The moving foil may have a surface velocity and a tangential velocity of the rotating container may be substantially equal to the surface velocity of the foil while transferring the metalized layer from the foil onto the surface of the container.

The method may further include printing and curing ink onto the container.

The method may further include positioning surfaces of the container tangentially proximal to the adhesive jetting and curing station.

These and other features and advantages of the present invention will become apparent from the following detailed description of illustrative embodiments thereof, which is to be read in connection with the accompanying drawings. Corresponding reference element numbers or characters indicate corresponding parts throughout the several views of the drawings.

### BRIEF DESCRIPTION OF THE DRAWINGS

FIG. 1 is a simplified schematic illustration of a system for transferring foil indicia from a foil or foil film onto a container according to the present invention.

FIG. 2 is a partial upper view a foil.

FIG. 3 is a cross-sectional view of the foil of FIG. 2 taken along the 3 -3 axis.

FIG. 4 is a schematic illustration showing details of an embodiment of the system of FIG. 1.

FIGS. 5A, 5B, 5C, 5D, and 5E are schematic illustrations of the transfer of foil indicia from a foil to a container according to the present invention.

FIG. 6 is a schematic illustration of a continuous rotary container transfer station according to the present invention.

FIG. 7 is an illustration of a system for holding and moving a container for the transfer of foil indicia from the web.

FIG. 8 is a schematic illustration showing details of another embodiment of the system of FIG. 1.

FIG. 9 is an exploded schematic illustration of the embodiment of the system of FIG. 8.

FIG. 10 is a schematic illustration of a continuous elongate container transfer station according to the present invention.

FIG. 11 is a schematic illustration of the present invention having an ink printing and curing station.

FIG. 12 is a schematic illustration of the present invention having multiple ink printing and curing stations.

FIG. 13A depicts a container within a container holder.

FIGS. 13B-13H depict motions of the container and holder of FIG. 13 relative to foil drum.

### DETAILED DESCRIPTION OF THE INVENTION

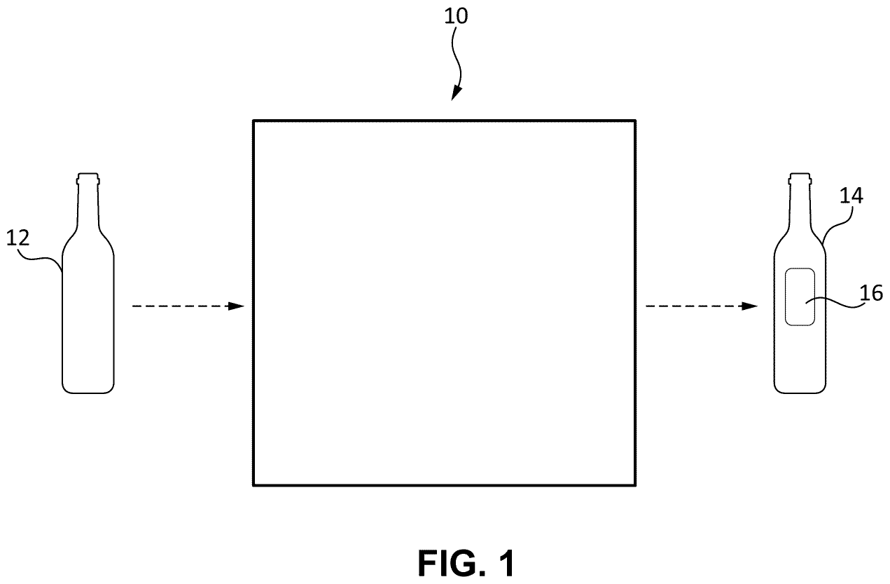

FIG. 1 is a simplified schematic illustration of the system 10 of the present invention. An article, such as a container 12, onto which foil indicia is to be applied is introduced into the system 10 of the present invention. The container 12 may be any container, such as but not limited to glass, plastic, metal, etc., useful in commercial, business, consumer, private, etc. applications. The system 10 provides a container 14 with applied foil indicia 16 thereon. The system 10 may also provide ink indicia. The foil indicia and/or ink indicia may provide information about the contents of the container, consumer information for the container, decoration or artwork for the container, marketing information for the container, and/or any other desired marking or labelling.

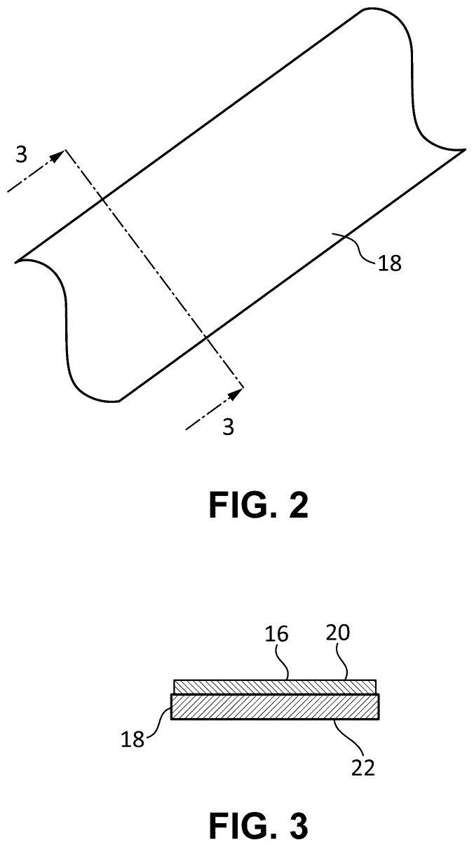

FIG. 2 is a partial top plan view of a portion of a foil 18. FIG. 3 is a cross-sectional view of the web of FIG. 2 taken along the 3-3 axis. The foil 18 includes a metalized layer or portion 20 disposed over a back or polymeric layer 22. Useful materials for the back or polymeric layer 22 may include, but are not limited to, polyethylene terephthalate (PET), polyethylene (PE), polypropylene (PP), polystyrene (PS), polyesters, polyamides, polyvinyl chloride, co-polymers such as styrene/acrylonitrile copolymers, ethylene/propylene copolymers, styrene/acrylonitrile copolymers, ethylene/butene-1, copolymers, ethylene/ethyl acrylate copolymers, ethylene/methyl methacrylate copolymers, ethylene/vinyl acetate copolymers.

Suitable materials for the release layers 24, 26 may include, but are not limited to, silicone, high density polyethylene, medium density polyethylene, low density polyethylene, polypropylene, polytetrafluoroethylene, acrylated silicone, polyesters, polyethylene terephthalate, polyethylene naphthylene, polyamides, co-polymers and mixtures thereof.

FIG. 4 is a schematic illustration showing further details of the system 10 according to the present invention. If the containers 12 are being processed in an upright or vertical orientation, then FIG. 4 may be considered as a top planar view with vertical parts orientation. The present invention is not limited to such an upright or vertical orientation for the container 12. For example, the containers 12 may be processed in an orientation where the containers 12 are on their sides as opposed to being upright. In such a case, FIG. 4 may be considered an elevational view with horizontal parts orientation.

In either case, the foil or foil film 18 is a continuous film from an unwind foil station 32 to a rewind foil station 34. Either or both of the unwind and rewind foil stations 32, 34 may have a rotating pulley or spindle 76 for moving the foil 18. In such a case the rotating pulley or spindle 76 may be mechanically configured for or associated with mechanical motive means, such as a motor. As depicted in FIG. 4 the foil 18 is unwound from the unwind web station 32 in a direction indicated by arrow “A” towards a foil station 36.

The foil 18 enters a foil indicia transfer station 37. The foil 18 is guided by conveyor belt 38 and a pulley or roller 40 engaging the conveyor belt 38. The foil 18 wraps around rotating device, such as a foil drum 54. Containers 12 enter the foil indicia transfer station 37 as indicated by arrow “B”. An infeed container station 42 individually transports containers 12 towards a continuous container transfer station 70, such as a rotary container transfer station or turret 43.

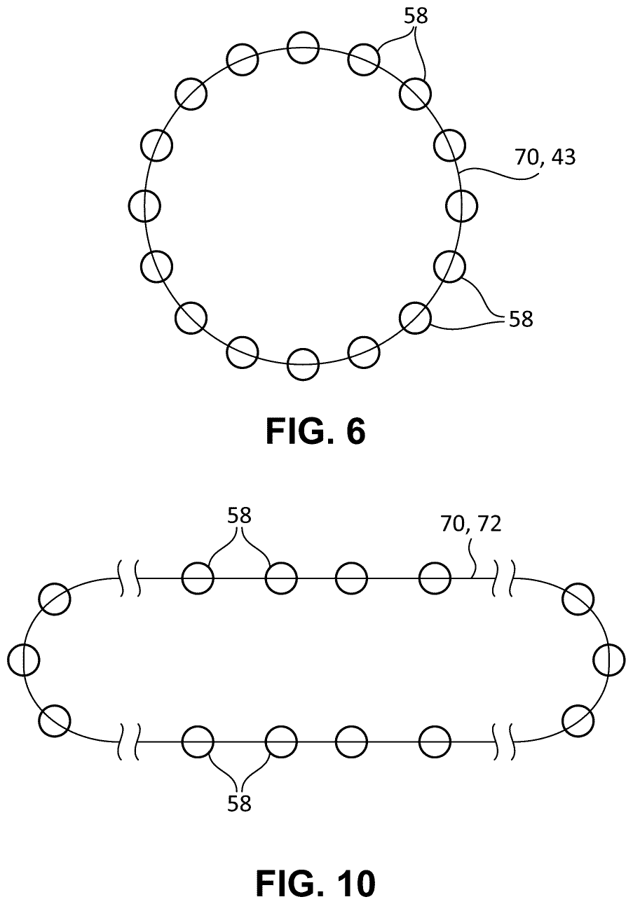

FIG. 6 schematically depicts continuous rotary container transfer station 70, such as the rotary container transfer station or turret 43. The continuous rotary container transfer station 70, 43 contains a plurality of container holders 58. In use, the continuous rotary container transfer station 70, 43 is in continuous motion while the indicia 16 is being applied to the container 12.

Returning to FIG. 4, the rotary container transfer station or turret 43 is shown as rotating in a clockwise direction “C”. The system of the present invention is not limited to a clockwise rotation of the rotary container transfer station or turret 43, and the rotary container transfer station or turret 43 may, if desired, rotate in the counter-clockwise direction. Adhesive is selectively and controllably applied to the container 12 at an adhesive jetting and curing station 46. Curing may be ultra-violet (UV) light curing. The adhesive may include a UV-curable pressure sensitive adhesive or a UV-curable contact adhesive. Such a curable adhesive, even at room temperature, will adhere to a multitude of container surfaces. The cured adhesive will, upon contact with the film 18, will adhesively transfer a portion of the metalized layer 20 or the foil indicia 16 from the web 18 onto the container 12.

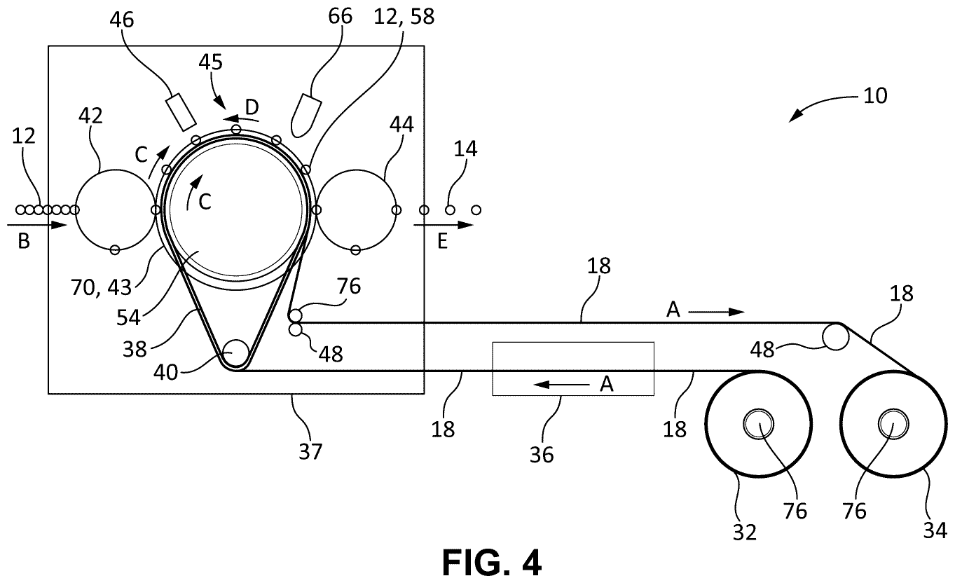

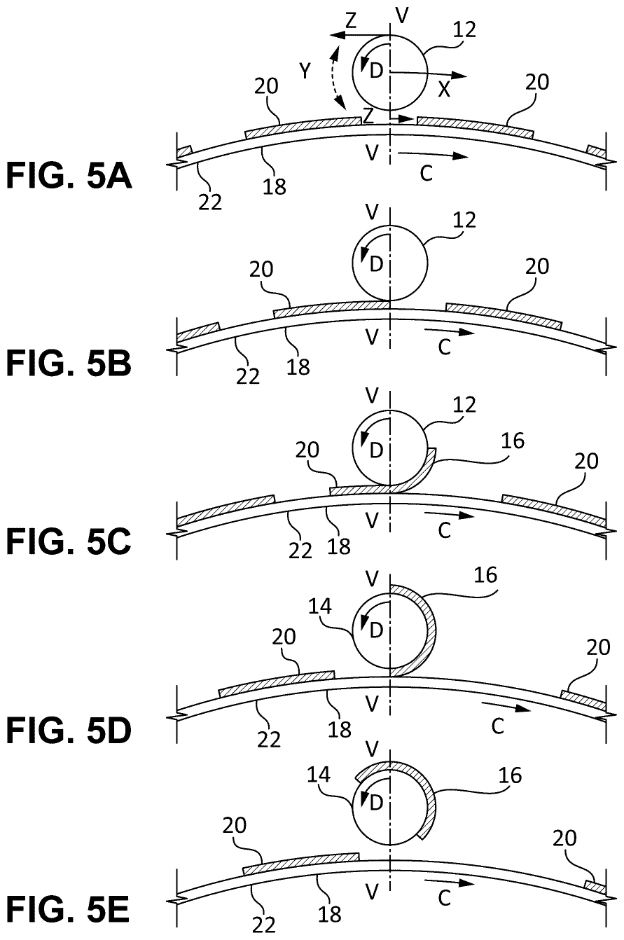

At a foil-container contact location 45, which is generally indicated by arrow “D”, the foil indicia is transferred from the foil 18 onto the container 12. Details of this transfer is further described below in conjunction with the description of FIGS. 5A-5F and 6. The system 10 may optionally include a camera or inspection module 66 for inspection of the applied foil indicia 16. After the foil indicia 16 is applied to the container 12 (and optionally inspected), the container is transported a discharge container station 44. The container 14 having the applied printing or indicia 16 exits the indicia transfer station 37 as indicated by arrow “E”. Further details of the infeed container station 42, the turret 43, and the discharge container station 44 are described in U.S. Patent Application Publications US 2021/0309022 A1 and US 2022/0219465 A1 both to Norwalt Design, Inc., the contents of both of which are incorporated herein in their entirety by reference.

The foil 18 exits the indicia transfer station 37 as indicated by arrow “E” to the rewind foil station 34. The foil 18 may be guided by rollers or pulleys 48. At the rewind foil station 34 the foil 18 is wound into a coil. Movement of the foil 18 is not limited to the use of the foil drum 54 for providing motive force to the foil 18. Other rotating devices, such as rotating pulleys or spindles 76, typically motorized, may be used, in conjunction or separately, for moving the foil 18. For example, movement of the foil 18 controlled by the unwind foil station 32 and/or the rewind foil station 34 through the use of motorized pulleys or spindles 76.

FIGS. 5A to 5F schematically illustrate the transfer of the foil indicia 16 from the foil 18 onto a container 12. While the metalized portion 20 of the foil film 18 is depicted as being partitioned or segmented, the metalized portion 20 of the foil film 18 may be a continuous

metalized layer 20. As depicted in FIG. 5A the foil 18 is moving or rotating in one direction about a lateral axis “V”, for example a clockwise direction of the moving turret 43 (not shown), as indicated by arrow “C”. The container 12 is also moving or rotating in the same direction about the lateral axis “V”, for example a clockwise direction, as indicated by arrow “D”. Arrow “Z” depicts the surface or tangential velocities. The surface or tangential velocity “Z” of the foil 18 should be equal, including substantially equal, to the tangential velocity “Z” of the container 12. Mathematically, if “X” indicates the revolutions per minute (rpm) of the container 12 and of “Y” surface length or circumference of the container 12 (or length per revolution of the container 12), then the foil 18 should be controllably traveling at a rate of “X times Y”. With the system 10 of the present invention the spinning or revolutions per minute of the container 12 and the speed of the foil 18 are independently controlled so that the tangential velocity of the container 12 and the tangential or surface velocity of the foil 18 are equal or at least substantially equal. This allows for proper and controllable deposition of the foil indicia 16 onto the container 12. Further, the system of the present invention may rotate a container 12 only when it is being proximally disposed, including juxtaposingly disposed, towards the foil 18.

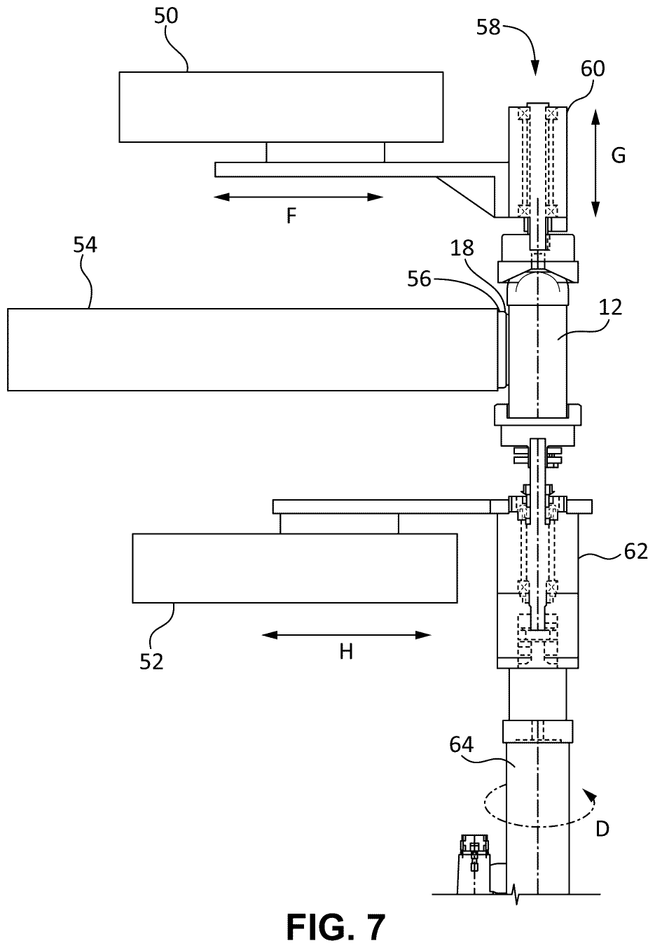

FIG. 5B schematically depicts the initial engagement of the rotating container 12 against the rotating foil 18. Such initial engagement is proximal juxtaposingly engagement of the container 12 and the foil metalized portion 20. Components for achieving such juxtaposingly engagement are described below in conjunction with FIG. 7. Referring back to FIG. 5B, the rotating container 12 having adhesive contacts the metalized portion 20 or the foil indicia 16.

As schematically depicted in FIG. 5C, the foil indicia 16 is being secured to the rotating container 12. The foil indicia 16 is being lifted away from the back layer 22 of the foil film 18. As schematically depicted in FIG. 5D, with continued, controlled rotation of the container 12 the foil indicia 16 is secured to the container 12. The release layer 26 of the indicia 16 remains on the rotating web 18. As schematically depicted in FIG. 5E, the container 14 having the adhesively secured foil indicia 16 is moved away from the rotating foil 18.

FIG. 7 depicts components for controllably securing, moving, and rotating the container 12. The container 12 is releasably secured within a container holder 58. In particular, the container 12 is releasably secured between an upper holder 60 and a lower holder 62. An upper motor 50 is mechanically associated with the upper holder 60. The upper motor 50 may be configured to provide controllable lateral motion, as indicated by arrow “F”, and/or controllable vertical motion, as indicated by arrow “G”, of the container 12 and the container holder 28. With the controllable lateral motion “F”, the upper motor 50 moves in and out from the rotary container transfer station or turret 43 to contact the foil 18. One aspect of the controllable vertical motion “G” is to provide up and down motion for releasably securing or clamping the container 12 within the container holder 58.

A lower motor 52 is mechanically associated with the lower holder 62. The lower motor 52 may be configured to provide controllable lateral motion, as indicated by arrow “H”, of the container 12 and the container holder 28. Thus, both the upper holder 60 and the lower holder 62 have independent motors 50, 52, respectively, for independently controlling different movements. Typically, however, the upper motor 50 and/or the lower motor 52 provide consistent or substantially consistent lateral movement.

The upper and lower motors 50, 52 may be any mechanical, pneumatic, electrical motors. Desirably, the upper and lower motors 50, 52 are servomotors.

A container holder motor 64 is provided for providing controllable rotation of the container 12. While the container holder motor 64 is depicted as being mechanically associated with the lower holder 62, the present invention is not so limited and other configurations may suitably be used. The upper holder 60 and the lower holder 62 may be separately mounted on the rotary container transfer station or turret 43. Such separate mounting may avoid interference between the container holder 58. Desirably, the container holder motor 64 is configured to rotate the container 12 through the use of one or more motors 64. The container, however, 12 may be rotated by other means, such as gearing or forced air flow.

The motors 50, 52, 64 may be used to control movement of the container 12 with respect to the foil film 18 at the foil-container contact location 45 and/or at the adhesive jetting and curing station 46.

Continuing with FIG. 7, a rotating device or foil drum 54, optionally having a belt 56 or other motive means such as gearing or motor, is provided for controllably moving and guiding the foil 18. The foil drum 54 may also optionally have a vacuum source to aid in control of the web. Such controllable contact is described above in conjunction with FIGS. 5A to 5E.

Returning to FIG. 4, an inspection module or camera 66 may be provided to monitor the controlled contact of the foil 18 and the container 12. In particular, the inspection module or camera 66 may monitor the proper placement of the foil indicia 16 onto the container 12. Feedback (not shown) may be provided from the inspection module or camera 66 to the upper servomotor 50, the lower servomotor 52, the container holder servomotor 64, and/or the web drum 54 to ensure proper deposition of the indicia 16 onto the container 12.

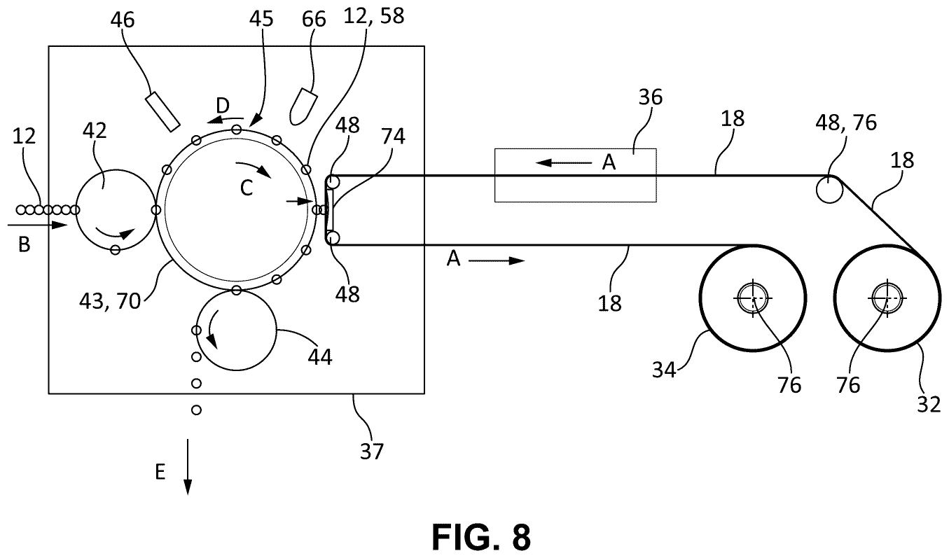

The present invention is not limited to the use of a foil drum 54 for guiding or moving the foil 18. For example, as schematically depicted in FIG. 8 the foil 18 may move from the unwind foil station 32 to a location proximal the continuous transfer station 70. The location may include web pulleys 48 and a backup guide 74. The foil 18 is disposed between the container 18 and the backup guide 74 at the foil-container contact location 45. The backup guide 74 may be rubber, plastic, or polymeric based material. The backup guide 74 should have some flexibility to ensure adequate contact between the foil 18 and the container 12 when the container holder 58 is controllably moved into the position for transferring the indicia 16 from the foil 18. As such the backup guide 74 may have a degree of elasticity to provide flexibility to the backup guide 74.

If the containers 12 are being processed in an upright or vertical orientation, then FIG. 8 may be considered as a top planar view with vertical parts orientation. The present invention is not limited to such an upright or vertical orientation for the containers 12. For example, the containers 12 may be processed in an orientation where the containers 12 are on their sides as opposed to being upright. In such a case, FIG. 8 may be considered an elevational view with horizontal parts orientation.

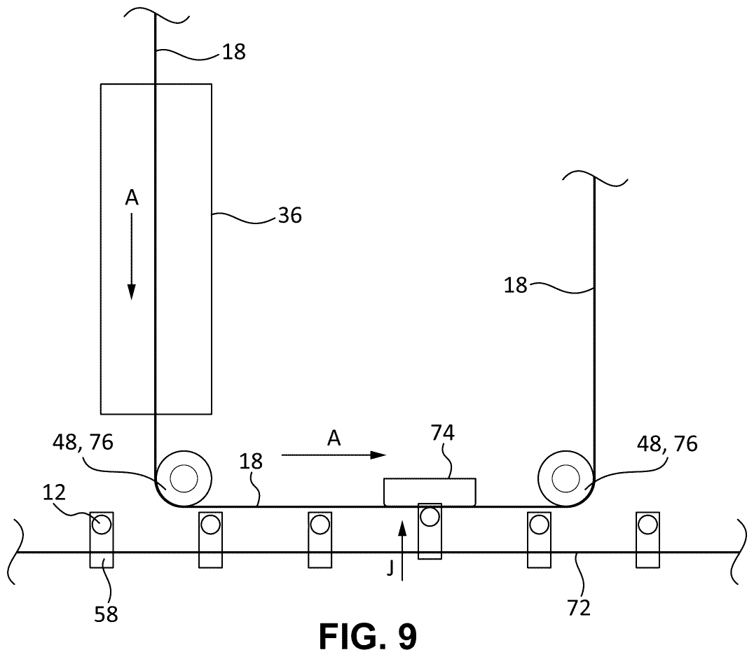

The embodiment of FIG. 8 is not limited to the use of the rotary container transfer station 43. For example, as depicted in FIGS. 9 and 10, an elongate container transfer station 72 may be used. As shown in FIG. 9, the elongate container transfer station 72 is a continuous system having a plurality of container holders 58. The elongate container transfer station 72 may be in the shape of an elongate rectangle having rounded ends, such as capsule-shaped configuration. As depicted in FIG. 9, a container holder 58 having a container 12 therein is transported to the foil-container contact location 45. At the foil-container contact location 45 the container 12 is moved against the foil 18, as indicated by arrow J, for the transfer of the foil indicia 16. As described above, rotation of the container 12 within the container holder 58 is controlled such that the tangential velocity of the container 12 is substantial equal to the surface velocity of the web 18.

As depicted in FIG. 11, the systems of the present invention may further include an ink printing and curing station 47 for applying ink onto the container 12 and/or onto the applied foil 16 on the container 12. The ink may include one or more colorants (e.g., one or more pigments, one or more dyes, or their mixtures). Colorants can provide the formulation with, for example, a desired color and/or opacity. Exemplary colors may include black, cyan, magenta, yellow, red, blue, green, brown, or their combinations.

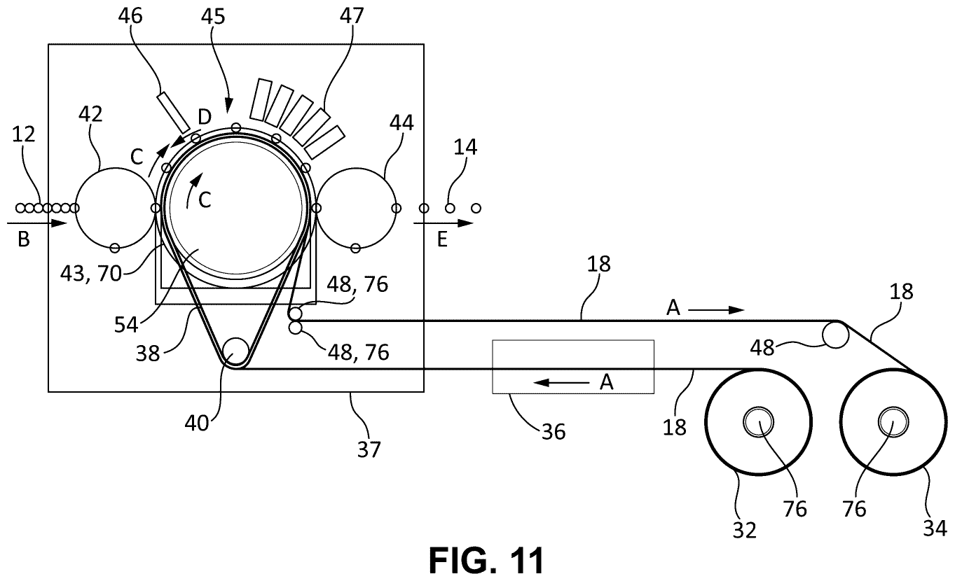

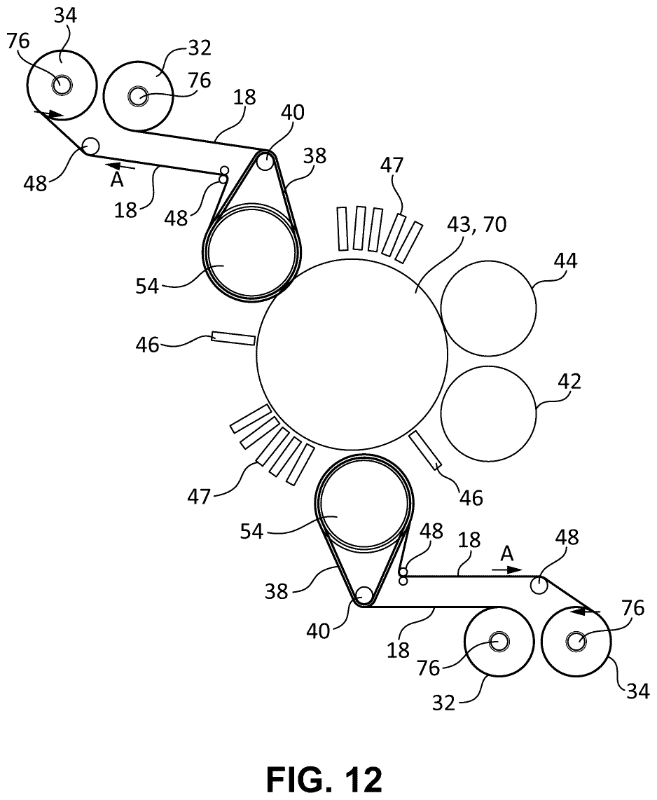

As depicted in FIG. 12, may include multiple apparatus for applying foil to containers. For example, the system of the present invention may include multiple adhesive jetting and curing stations 46; multiple ink printing and curing stations 47; multiple unwind and rewind foil stations 32, 34; and multiple rotating film drums 54 all associated with a single continuous transfer station 43, 70. Such an embodiment may include single infeed and discharge container stations 42, 44. If desired, there may be multiple infeed and discharge container stations 42, 44.

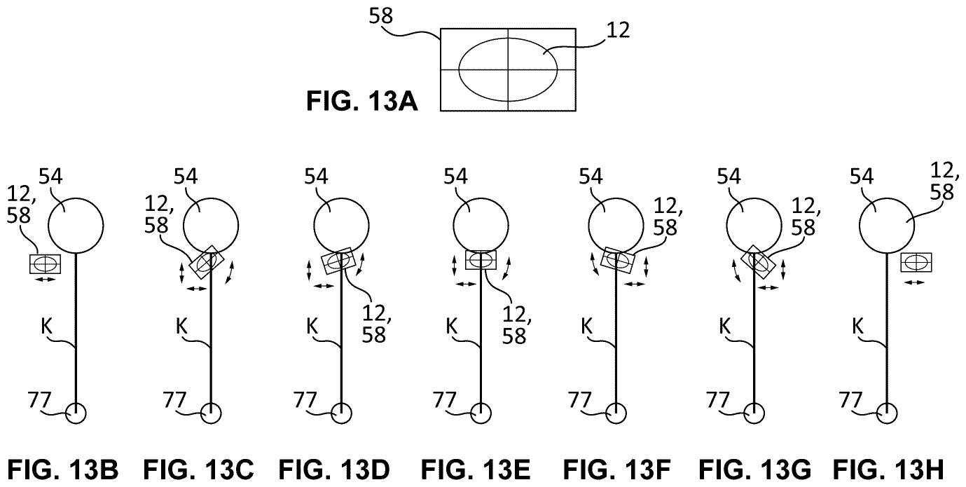

FIG. 13A depicts a container 12 disposed within a container holder 58. The container may be oval or oblong shaped as depicted in FIG. 13A. The container 12, however, may have other non-circular or circular shapes. FIGS. 13B-13H depict controllable motions the container 12 and the container holder 58 with respect to the film drum 54. Location 77 represents a center point of a portion of the rotary container transfer station or turret 43. Axis K represents a center line between location 77 and the film drum 54. As depicted in FIG. 13B, the container 12 and the container holder 58 may be laterally moved towards the film drum 54. As depicted in FIGS. 13C-13G, the container 12 and the container holder 58 may be moved in multiple directions, such as lateral, inward, outward, upward, downward, and tilting directions, to ensure adequate contact between the container 12 and the film drum 54 for the transfer of the film indicia 16 onto a container 12, such as a non-circular container or a container having non-circular surface portions. After the film indicia 16 is applied onto the container 12, the container 12 and the container holder 58 may be moved away from the film drum 54 as shown in FIG. 13H.

The motions of the container 12 and the container holder 58 in FIGS. 13B-13H may also be applied to the adhesive jetting and curing station 46. Such controllable motions are useful for the selective application of adhesive onto the container 12.

Such controllable motions are described in U.S. Patent Application Publications US 2021/0309022 A1 and US 2022/0219465 A1 both to Norwalt Design, Inc., the contents of both of which are incorporated herein in their entirety by reference.

While various embodiments of the present invention are specifically illustrated and/or described herein, it will be appreciated that modifications and variations of the present invention may be affected by those skilled in the art without departing from the spirit and intended scope of the invention. Further, any of the embodiments or aspects of the invention as described in the claims or in the specification may be used with one and another without limitation.

Element reference numbers, letters, and/or symbols in the following embodiments or aspects of the present invention are presented merely for ease of comprehension and are not to be construed as limiting the scope of the present invention. Further, the following embodiments or aspects of the invention may be combined in any fashion and combination and be within the scope of the present invention, as follows:

### Embodiment 1. a System (10) for Applying Foil (16) Onto a Surface of a Container (12), comprising:

an elongate foil (18) having a metalized layer (20) and a base layer (22);
a rotating device (54, 76) for moving the elongate foil (18);
a continuous container transfer station (43, 70, 72) having a plurality of container holders, each one of the plurality of container holders (58) for releasably securing a container (12), the continuous container transfer station (43, 70, 72) configured for moving the container (12) from an infeed container station (42) to a foil-container contact location (45); and
an adhesive jetting and curing station (46) for applying and partially curing adhesive; wherein each one of the plurality of container holders (58) comprises a motor system (50, 52, 62) for moving the container (12) into contact with the foil (18) and for moving the container (12) away from contract with the foil (18) and for rotating the container (12);
wherein, upon contact of the container (12) to the foil (18), a portion (16) of the metalized layer (20) is transferred from the foil (18) to the container (12); and
wherein the motor system (64) rotates the container (12) whereby a tangential velocity of the container (12) is substantially equal to a surface velocity of the foil (18) at a point of the foil-container contact location (45).

Embodiment 2. The system (10) of embodiment 1, wherein the rotating device (54, 76) is a foil drum (54) for guiding the foil (18).

Embodiment 3. The system of embodiment 2, further comprising a belt (38, 56), a motor, a pinion gear system, or other means for rotating the foil drum (54) controls the tangential velocity of the foil (18) at the foil-container contact location (45).

Embodiment 4. The system (10) of embodiment 1, wherein the rotating device (54, 76) is a rotating spindle or pulley (76) for moving and controlling the tangential velocity of the foil (18) at the foil-container contact location (45).

Embodiment 5. The system of embodiment 4, further comprising a backup guide (74) for guiding the foil (18) at the foil-container contact location (45).

Embodiment 6. The system (10) of embodiment 3, wherein the motor system (64) controls the tangential velocity of the container (12) at the foil-container contact location (45).

Embodiment 7. The system (10) of embodiment 4, wherein the motor system (64) controls the tangential velocity of the container (12) at the foil-container contact location (45).

Embodiment 8. The system (10) of embodiment 1 or any previous embodiments, wherein the container holder (58) comprises an upper container holder (60) and a lower container holder (62); and wherein the motor system (50, 52, 64) comprises first and second motors (50, 52, 64) mechanically associated with the upper container holder (60) and/or mechanically associated with the lower container holder (62).

Embodiment 9. The system (10) of embodiment 8 or any previous embodiments, wherein the first and second motors (50, 52, 64) are configured to controllably move the upper and lower container holders (60, 62) towards and away from the foil (18) and/or to rotate the container (12).

Embodiment 10. The system (10) of embodiment 1 or any previous embodiments, wherein the container (12) has a substantially circular cross-section where the foil (20) is being applied thereto.

Embodiment 11. The system (10) of embodiment 1 or any previous embodiments, wherein the motor system (50, 52) is further configured for positioning the container (12) proximal to the adhesive jetting and curing station (46).

Embodiment 12. The system (10) of embodiment 11, wherein the motor system (50, 52) is further configured for positioning surfaces of the container (12) juxtaposingly proximal to the adhesive jetting and curing station (46).

Embodiment 13. The system (10) of embodiment 12, wherein the motor system (50, 52) is further configured for positioning surfaces of the container (12) tangentially proximal to the adhesive jetting and curing station (46).

Embodiment 14. The system (10) of embodiment 12 or 13, wherein the container (12) has a non-circular cross-section where the foil (20) is being applied thereto.

Embodiment 15. The system (10) of embodiment 14, wherein the container (12) has an oblong cross section where the foil (20) is being applied thereto.

Embodiment 16. The system (10) of embodiment 1 or any previous embodiments, further comprising an ink printing and curing station (47) for printing ink onto the container (12).

Embodiment 17. A method for printing foil (16) onto a surface of a container (12), comprising:
providing an elongate foil (18) having a metalized layer (20) and a base layer (22);
providing a rotating device (54, 76) for moving the elongate foil (18);
providing a container (12) releasably secured within a container holder (58);
providing a continuous container transfer station (43, 70, 72) having a plurality of container holders (58);
providing a motor system (50, 52, 64) mechanically associated with each one of the plurality of container holders (58) for moving the container (12) towards the foil (18) and for rotating the container (18);
providing adhesive jetting and curing station (46);
applying and partially curing adhesive onto a surface of the container (12);
contacting the rotating container (12) and the moving foil (18) at a foil-container contact location (45); and
adhesively transferring a portion (16) of the metalized layer (20) from the foil (18) onto a surface of the container (12) while the continuous container transfer station (43, 40, 72) is moving the container (12) from an infeed container station (42) to the foil-container contact location (45).

Embodiment 18. The method of embodiment 17, wherein the moving foil (18) has a surface velocity and wherein a tangential velocity of the rotating container (12) is substantially equal to the surface velocity of the foil (18) while transferring the metalized layer from the foil (16, 20) from the foil (18) onto the surface of the container (12).

Embodiment 19. The method of embodiments 17-18, further comprising: printing and curing ink onto the container (12).

Embodiment 20. The method of embodiments 17-19, further comprising: positioning surfaces of the container (12) tangentially proximal to the adhesive jetting and curing station (46).

What is claimed is

1. A system for applying foil indicia onto a surface of a container, comprising:
an elongate foil having a metalized layer and a base layer;
a rotating device for moving the elongate foil;
a continuous container transfer station having a plurality of container holders, each one of the plurality of container holders for releasably securing a container, the continuous container transfer station configured for moving the container from an infeed container station to a foil-container contact location; and
an adhesive jetting and curing station for applying and partially curing adhesive;
wherein each one of the container holders comprise a motor system for moving the container into contact with the foil and for moving the container away from contact with the foil, and for rotating the container;
wherein, upon contact of the container to the foil, a portion of the metalized layer is adhesively transferred from the foil to the container; and
wherein the motor system rotates the container whereby a tangential velocity of the container is substantially equal to a surface velocity of the foil at a point of the foil-container contact location.

2. The system of claim 1, wherein the rotating device is a foil drum for guiding the foil.

3. The system of claim 2, further comprising a belt, a motor, a pinion gear system, or other means for rotating the foil drum controls the tangential velocity of the foil at the foil-container contact location.

4. The system of claim 1, wherein the rotating device is a rotating spindle or pulley for moving and controlling the tangential velocity of the foil at the foil-container contact location.

5. The system of claim 4, further comprising a backup guide for guiding the foil at the foil-container contact location.

6. The system of claim 3, wherein the motor system controls the tangential velocity of the container at the foil-container contact location.

7. The system of claim 4, wherein the motor system controls the tangential velocity of the container at the foil-container contact location.

8. The system of claim 1, wherein the container holder comprises an upper container holder and a lower container holder; and wherein the motor system comprises first and second motors mechanically associated with the upper container holder and/or mechanically associated with the lower container holder.

9. The system of claim 8, wherein at least one of the first and second motors are configured to controllably move the upper and lower container holders towards and away from the foil and/or to rotate the container.

10. The system of claim 1, wherein the container has a substantially circular cross-section where the foil is being applied thereto.

11. The system of claim 1, wherein the motor system is further configured for positioning the container proximal to the adhesive jetting and curing station.

12. The system of claim 11, wherein the motor system is further configured for positioning surfaces of the container juxtaposingly proximal to the adhesive jetting and curing station.

13. The system of claim 12, wherein the motor system is further configured for positioning surfaces of the container tangentially proximal to the adhesive jetting and curing station.

14. The system of claim 12, wherein the container has a non-circular cross-section where the foil is being applied thereto.

15. The system of claim 14, wherein the container has an oblong cross-section where the foil is being applied thereto.

16. The system of claim 1, further comprising an ink printing and curing station for printing ink onto the container.

17. A method for applying foil indicia onto a surface of a container, comprising:
providing an elongate foil having a metalized layer and a base layer;
providing a rotating device for moving the elongate foil;
providing a container releasably secured within a container holder;
providing a continuous container transfer station having a plurality of container holders;
providing a motor system mechanically associated with each of the container holders for moving the container towards the foil and for rotating the container;
providing adhesive jetting and curing station;
applying and partially curing adhesive onto a surface of the container;
contacting the rotating container and the moving foil at a foil-container contact location; and
adhesively transferring a portion of the metalized layer from the foil onto the surface of the container while the continuous container transfer station is moving the container from an infeed container station to the web-container contact location.

18. The method of claim 17, wherein the moving foil has a surface velocity and wherein a tangential velocity of the rotating container is substantially equal to the surface velocity of the foil while transferring the metalized layer from the foil onto the surface of the container.

19. The method of claim 17, further comprising: printing and curing ink onto the container.

20. The method of claim 17, further comprising: positioning surfaces of the container tangentially proximal to the adhesive jetting and curing station.
